(19) United States
(12) Patent Application Publication
(10) Pub. No.: US 2026/0044408 A1
(43) Pub. Date: Feb. 12, 2026

(54) ERROR DETECTION AND DEBUG TECHNIQUES FOR PROCESSING-IN-MEMORY ARCHITECTURES

(71) Applicant: Google LLC, Mountain View, CA (US)

(72) Inventors: Alekhya Perugupalli, San Jose, CA (US); Hongil Yoon, San Jose, CA (US); Inho Hwang, San Diego, CA (US); Benjamin Youngjae Cho, Mountain view, CA (US)

(21) Appl. No.: 19/291,493

(22) Filed: Aug. 5, 2025

Related U.S. Application Data
(60) Provisional application No. 63/680,458, filed on Aug. 7, 2024.

(51) Int. Cl. G06F 11/07

(52) U.S. Cl. CPC G06F 11/0793; G06F 11/073; G06F 11/079

(57) ABSTRACT

Methods, systems, and apparatus, including computer programs encoded on computer storage media, for error detection of a processing-in-memory (PiM) subsystem that includes one or more integrated compute elements and one or more memory devices. One method can include executing, by the one or more integrated compute elements, instructions to perform a set of PiM operations on data stored in the one or more memory devices; upon execution of each PiM operation, storing, in a set of registers included in the PiM subsystem, PiM operation execution data, the PiM operation execution data including (1) a count indicating a number of PiM operations that have been executed and (2) data identifying previously-executed PiM operations; determining, during execution of the set of PiM operations, that a first error has occurred; in response to determining that the first error has occurred, stopping execution of further PiM operations.

### CROSS-REFERENCE TO RELATED APPLICATION

This application claims the benefit of U.S. Provisional Application No. 63/680,458, filed on Aug. 7, 2024. The disclosure of the prior application is considered part of and is incorporated by reference in the disclosure of this application.

### TECHNICAL FIELD

This specification generally relates to an architecture for executing computations in a processing-in-memory (PiM) architecture.

### BACKGROUND

Modern computing systems often incorporate a wide variety of compute processing units, each offering different computing capabilities and trade-offs. Efficient execution of a given compute job often involves parsing computations into meaningful sub-tasks or workloads that are mapped to available processor cores of a computing system. The computations may be parsed and mapped based on suitability criteria, such as processor capability, performance, and power. Generally, this overall process of allocating portions of a compute to appropriate processor resources is referred to as heterogeneous compute.

For example, a system-on-a-chip (SoC) can include multiple different processing cores, e.g., an Intellectual Property block (“IP block”) that executes a respective portion of a computational operation for different use cases. An example use case can involve processing image or speech data captured respectively by a camera or microphone on the mobile device. The SoC can use a heterogeneous compute operation to process input samples derived from the image data, the speech data, or both. An example step in the heterogeneous compute operation can include providing input samples from the image data to a neural network processor or machine-learning (ML) engine of the SoC to generate an inference output.

Some systems support heterogeneous computing using memory devices with processing-in-memory (PiM) architectures. Such memory devices typically include (1) one or more memory arrays to support operating as a memory, e.g., a dynamic random access memory (DRAM), for processing units of the system (e.g., a central processing unit or CPU) and (2) one or more integrated compute elements that are operable to execute instructions on data stored in the memory arrays and to store the resulting outputs of the executed instructions in the memory arrays without transferring the data or the resulting outputs to registers belonging to the CPU. In some implementations, the PiM compute elements can include MAC units, registers, queues, and FIFOs.

Such devices thus operate to provide two primary services for a heterogenous computing system: (1) memory service operations and (2) PiM operations. In other words, one or more components of a computing system can provide such memory devices with PiM architectures (also referred to herein as PiM devices) with a memory service request to fetch values stored in memory, e.g., as a result of executing a load instruction. Additionally, or alternatively, one or more components of a computing system can provide such PiM devices with a PiM operation request to perform a sequence of computations on a range of data values, e.g., by specifying one or more instructions and a range of memory addresses. In that case, the compute elements of such PiM devices can perform the requested computations on the range of memory addresses while also storing the results in the memory. Moreover, such PiM devices can respond to the requesting system component to indicate that the PiM operations have completed.

PiM devices can encounter errors during operation. Examples of such errors include (1) underflows and overflows of buffers/queues, (2) invalid target registers, and (3) invalid PiM commands. When an error occurs, current PiM architectures may not include a mechanism to detect the specific error that occurred, nor include a logging mechanism to log commands that can be evaluated from an error debugging standpoint. Also, when an error occurs in the peripheral PiM logic, current solutions may reset the entire DRAM array, thereby losing the data in the DRAM array at the time that the error occurs.

### SUMMARY

This specification describes techniques for error detection and debug capability in PiM architectures. In some implementations, the techniques can include implementing (1) a status register to capture error events and control logic in the PiM DDR to update the status register when an error occurs, (2) a counter that identifies the sequence of commands leading to the error, (3) a command history register to capture the last n number of commands that were executed, where n is an integer greater than or equal to 1, and (4) a power down and restart mechanism for PiM peripheral logical, such that the recovery and restart upon occurrence of the error is limited to PiM logic and not the entire DRAM array.

In some implementations, the set of registers include an operation counter register and an operation history register, the operation counter register storing the count indicating the number of PiM operations in the set of PiM operations instructions that have been executed, and the operation history register storing data identifying previously-executed PiM operations until the error occurred.

In some implementations, the method further includes determining that the first error has occurred includes detecting, by the PiM subsystem, an error in execution of the set of PiM operations, and, in response to detecting the error, updating, by the PiM subsystem, a value of an error status register, where the value of the error status register indicates a type of error for the first error.

In some implementations, the method further includes executing, by the CPU, instructions to perform an operation including sending a PiM reset command to the PiM subsystem, wherein the PiM reset command requests resetting power to the one or more integrated compute elements of the PiM subsystem.

In some implementations, the method further includes selectively resetting, by the PiM subsystem, power to the one or more integrated compute elements of the PiM subsystem.

In some implementations, the PiM subsystem includes a power control switch that couples the one or more integrated compute elements of the PiM subsystem to a power supply, and the method further includes, in response to receiving the PiM reset command, activating the power control switch to selectively reset power to the one or more integrated compute elements of the PiM subsystem, where activation of the power control switch does not interrupt power to the one or more memory devices of the PiM subsystem.

In some implementations, the host device is a system-on-a-chip having a plurality of computing components including the CPU.

In some implementations, executing, by the CPU, instructions to perform an operation including sending a PiM reset command to the PiM subsystem includes receiving the PiM reset command as a mode register (MR) bit based on receiving the MRW command, and, in response to updating the MR bit, controlling the power control switch of the PiM subsystem.

Particular embodiments of the subject matter described in this specification can be implemented so as to realize one or more of the following advantages.

The techniques described in this specification improve the reliability of PiM processing by enabling a host system to detect an error close in time to when the error occurs. In particular, the described system can implement a programmable debugging status register, a rolling command counter, and/or a PiM command history buffer, which provide a robust error visibility framework that supports high-resolution analysis of the PiM architecture. Thus, the techniques described herein enable effective error debugging during PiM operations by virtue of the implementation of the status, command count, and command history registers that assist a host processor during debug to identify the sequence of commands as well as the specific commands that led to the error. This enables early detection and precise classification of fault types, such as queue overflows, invalid command execution, and register targeting errors.

Additionally, the use of rank-level granularity in logging and control enables parallelism in monitoring and recovery across memory banks, thereby increasing system throughput and reducing recovery bottlenecks. In particular, the techniques described herein further enable resetting of PiM peripheral logic only (and not the entire DRAM array), thereby avoiding loss of data stored in the DRAM when the error occurs. Selective power gating mechanisms triggered via mode register writes allow fault isolation and recovery of PiM logic in microseconds, avoiding the disruptive latency and resource overhead associated with full DRAM resets by supporting enhanced system uptime, reduced mean-time-to-recovery (MTTR), and efficient re-use of intermediate computation results, all of which contribute to improved system resilience, performance scalability, and energy efficiency.

Further still, these described techniques enable the host device to restart PiM operations from the sequence of instructions that caused the error and leveraging the data already stored in DRAM, thereby avoiding redundant computations and operations that would be performed upon a full memory device reset.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system that uses a PIM device.

FIG. 2 illustrates an example system that uses a PiM architecture.

FIG. 3 illustrates an example system that uses a PiM architecture.

FIG. 4 illustrates an example system that uses a processor-in-memory architecture, and which is configured to reset only PiM logic upon an error occurring during PiM command execution.

FIG. 5 is a flowchart of an example process for the PIM device.

Like reference numbers and designations in the various drawings indicate like elements.

### DETAILED DESCRIPTION

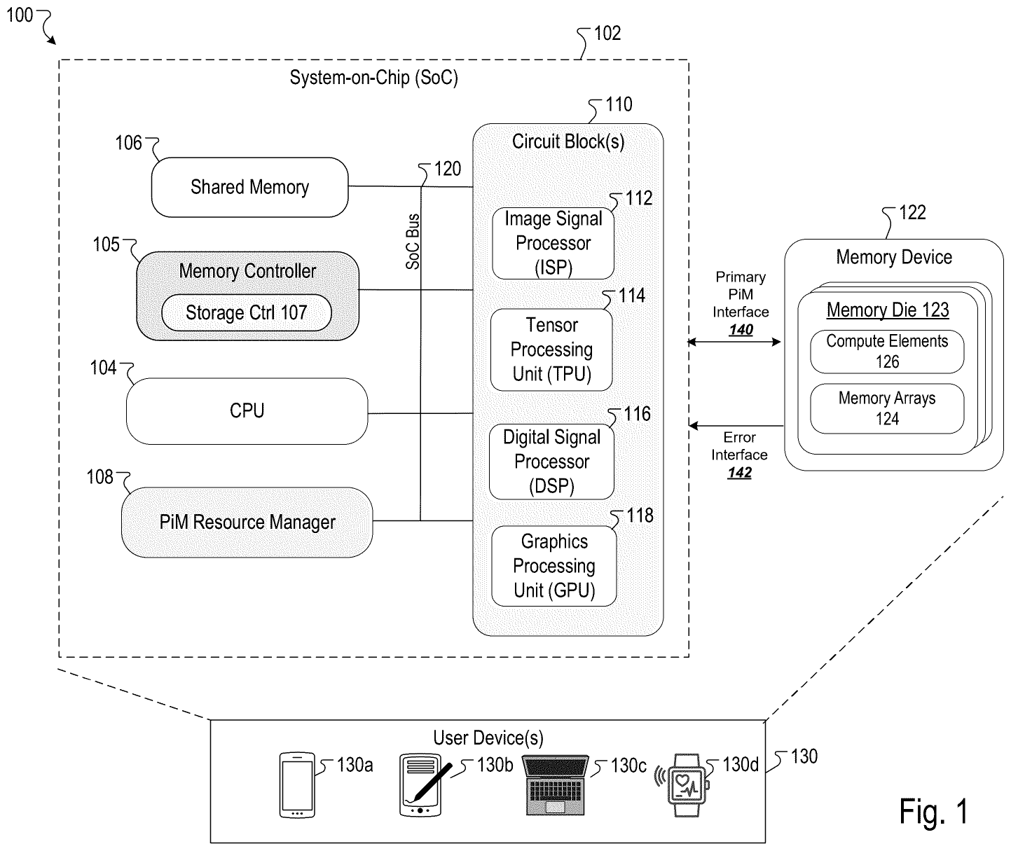

FIG. 1 is a block diagram of an example computing system 100 that uses a PiM device 122. In this example, the system includes a host device, which is referred to as a system-on-a-chip (“SOC”) 102 and a memory device 122 that has a PiM architecture. In other words, the memory device 122 can serve as a DRAM device for the system 100 and can also receive and perform PiM operations on data stored in the DRAM. The memory device 122 includes integrated compute elements 126 that can execute instructions directly on data stored in memory arrays, thereby enabling compute-in-memory operations without transferring data to the SOC.

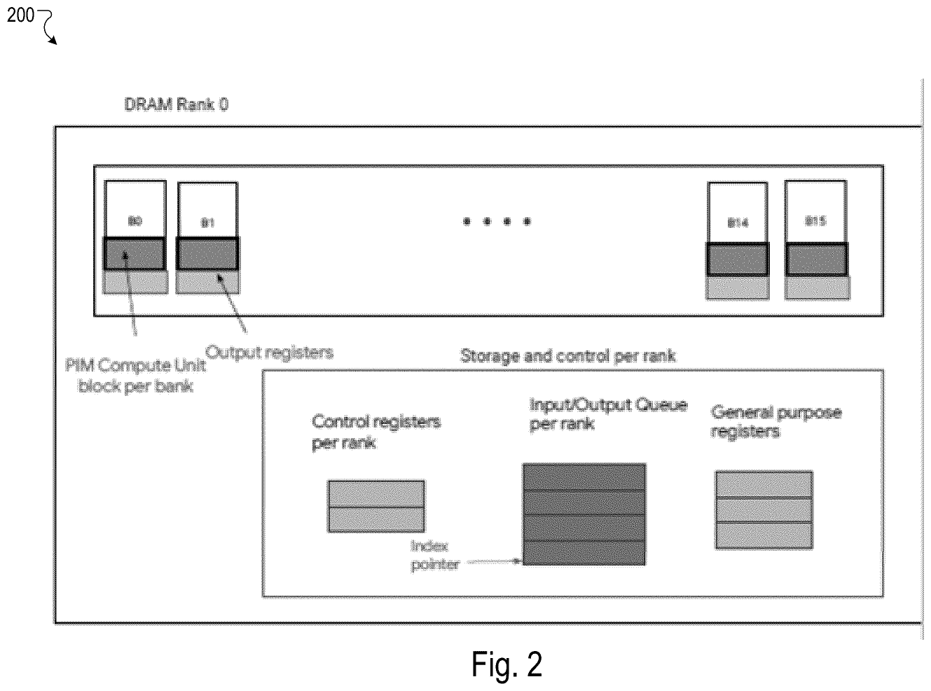

In general, the SOC 102 can issue PiM requests to the memory device 122 using a primary PiM interface 140 and can receive error data back from the memory device 122 using a separate error interface 142. This functionality is described in more detail below with reference to FIG. 2.

The system 100 is an example of a subsystem that can be installed on any appropriate user device. In the example of FIG. 1, the system 100 is an integrated subsystem of an example user device 130, which can be a consumer electronic device or mobile device, which can be, for example, a smartphone 130a, a tablet computer 130b, a laptop 130c, a smartwatch 130, another type of wearable device, an eNotebook, a Netbook, a smart speaker, or a mobile computer, to name just a few examples. In some other implementations, the system 100 is an integrated subsystem of a desktop computer, a network server, or any other appropriate cloud-based computing system.

The SoC 102 includes a central processing unit 104 (“CPU 104”), a memory controller 105, a shared memory 106 (“memory 106”), a PiM resource manager 108, and a circuit block 110. In some implementations, system 100 can include multiple SoCs and any descriptions for the SoC 102 will apply equally to each of the multiple SoCs that may be included at system 100.

The CPU 104 can be a general-purpose CPU (e.g., a single or multi-core CPU) that can execute the primary functionality of the user device 130. The CPU 104 generates one or more indicators, such as an application launch indicator or a function call that is triggered in response to executing or launching an application at a user device. For example, the application can be a camera application that uses an imaging sensor to generate image data or a gaming application that requires substantial memory and graphics processing resources to render graphical content of the game. The CPU 104 also generates one or more application values, such as pixel values or frame rate. The application values can be associated with a function call, can be descriptive of an event that occurs during execution of the application, or both.

The shared memory 106 is a memory subsystem that can be shared by other components of the SoC 102. In the example of FIG. 1, the shared memory 106 is depicted as being external to the circuit block 110. However, the shared memory 106 can include portions of memory that are: (i) specific to the circuit block 110; (ii) external to the circuit block 110, or (iii) both. The shared memory 106 can be random access memory of the SoC 102, such as static random access memory (SRAM), dynamic random access memory (DRAM), a synchronous DRAM (SDRAM), or double data rate (DDR) SDRAM.

In some implementations, aspects of the shared memory 106 are configured as a shared scratchpad memory that supports parallel access of its memory resources by two or more components of the SoC 102. The shared memory 106 can also include various other types of memory subsystems, such as, e.g., high bandwidth memory (HBM), narrow memory (e.g., for storing 8-bit values), or wide memory (e.g., for storing 16-bit or 32-bit values).

The circuit block 110 generally includes individual IP devices, such as processors, processor cores, or special-purpose processing devices. For example, the circuit block 110 can include an image signal processor (ISP) 112, a tensor processing unit (TPU) 114, a digital signal processor (DSP) 116, and a graphics processing unit (GPU) 118. The circuit block 110 can include one or more proprietary hardware elements. For example, each of the ISP 112, TPU 114, DSP 116, and GPU 118 can be a respective proprietary IP block (or IP device) of a particular entity or device manufacturer.

The PiM resource manager 108 can be implemented in hardware, software, or a combination of these. Aspects of the PiM resource manager 108 can be also implemented as firmware of the SoC 102 or firmware of a device of the SoC 102. For example, the PiM resource manager 108 can include resources such as flip-flops, registers, buffers, etc., that are implemented in hardware and can have control logic (e.g., programmed code) that is implemented in software. One or more aspects of the PiM resource manager 108 can be implemented as a software routine (or module) of the CPU 104, which uses one or more hardware resources of the CPU 104, such as registers, buffers, etc.

The CPU 104 can be configured as an instruction and vector data processing engine that processes data obtained from the shared memory 106, the memory device 122, or both. In some implementations, each processor (e.g., ISP 112, DSP 116, TPU 114, GPU 118) of the SoC 102 uses the PiM resource manager 108 to generate control signaling to manage and distribute PiM requests to perform memory-intensive compute operations to the memory device 122 to minimize the processing load at each core of the processors. The control signaling can be routed through the system 100 using an example bus 120 of the SoC 102. The control signaling can include commands, requests, data, instructions, or combination of these.

The PiM resource manager 108 cooperates with the CPU 104, memory controller 105 and storage controller 107 to dynamically control and manage one or more PiM operations to be performed by the memory device 122.

The memory device 122 can include multiple memory dies, each having one or more memory arrays for implementing the memory functionality of the memory device 122. For example, the memory device 122 can include N memory dies, where N is an integer greater than 1. The memory device 122 can implement a dynamic random-access memory (DRAM) or Double Data Rate (DDR) synchronous DRAM (SDRAM). The memory device 122 is configured to perform or support various types of PiM operations, which in this specification can also include compute-in-memory operations (CIM operations), and memory-near-computing operations (“MnC operations”). The memory device 122 performs or supports these operations using its multiple PiM compute elements, which are described below with reference to FIGS. 2-4.

The SoC 102 cooperates with the memory device 122 to perform PiM computations across one or more memory dies 123 of the memory device 122. The computations can be for operations or workloads that involve processes executed by one or more of the processors in the circuit block 110. Alternatively, or in addition, the PiM computations performed by the memory device 122 can be part of a heterogenous operation that spans multiple processors of circuit block 110, multiple circuit blocks 110, or both. In at least one example the memory device 122 is external to the SoC 102, whereas in another example the memory device 122 can be internal to the SoC 102.

In an example operation, a component of the SoC 102 initiates a request to perform PiM operations on the memory device 122. For example, the component can communicate with the PiM resource manager 108 to provide a sequence of one or more instructions to be performed over a range of memory addresses by compute elements 126 of the memory device 122. The SoC 102 then provides data representing the sequence of instructions and the range of memory addresses to the memory device 122 over the primary PiM interface 140.

The memory device 122 receives the data representing the sequence of instructions as well as the addresses over which to perform the PiM operations on the primary PiM interface 140. The memory device 122 distributes the instructions among compute elements 126. Each of the compute elements 126 can be a separate processor that can perform instructions according to a PiM instruction set that defines supported PiM operations. In some implementations, the memory device 122 distributes the sequence of instructions among the multiple compute elements 126 in a SIMD (single instruction, multiple data) fashion or another type of parallel processing technique.

After the PiM operations have completed, the memory device 122 can provide an indication that the operations have been completed to the SoC 102 over the primary PiM interface 140. The PiM resource manager 108 can then notify the requesting processing component that the PiM operations have completed and that the corresponding process can continue.

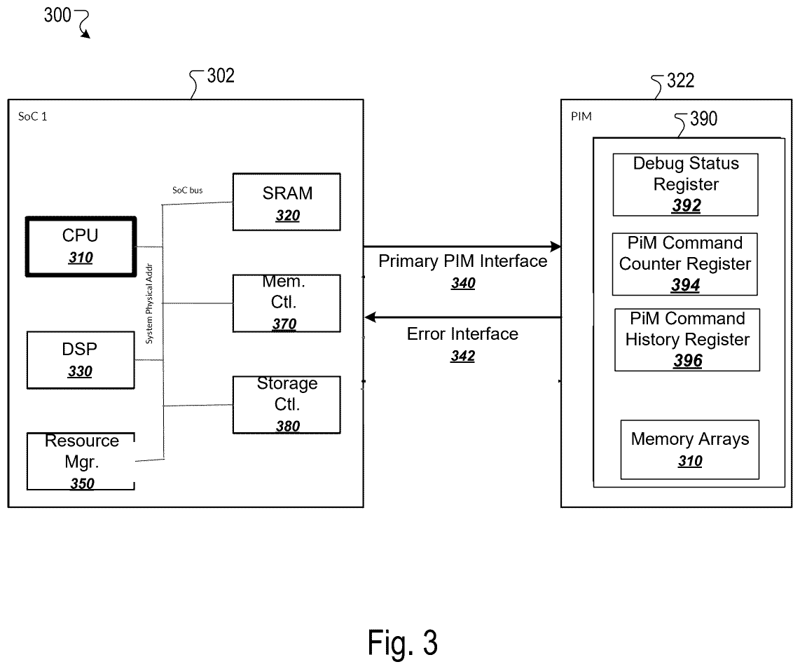

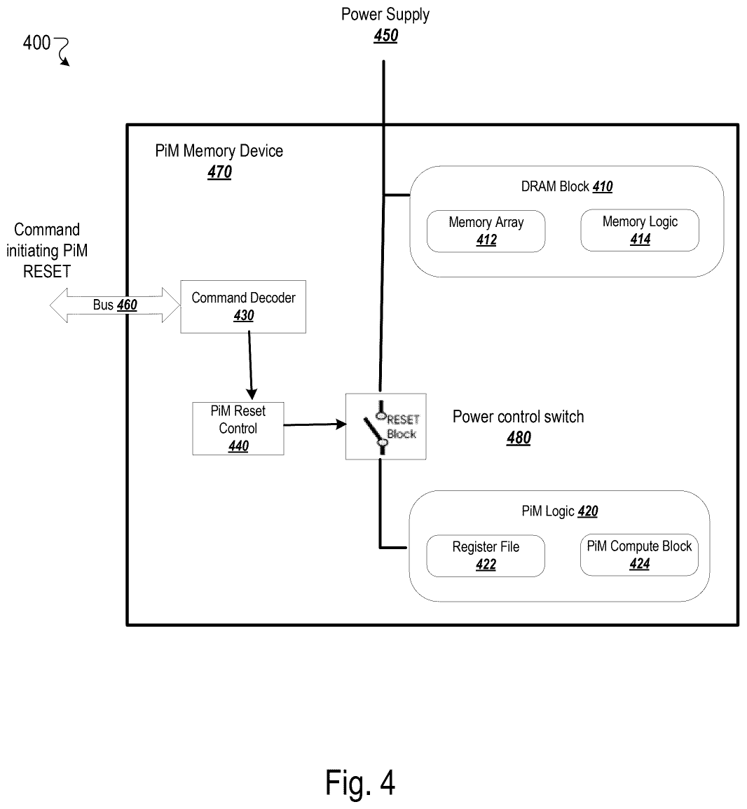

If an error occurs while performing the PiM operations, the memory device 122 can provide an indication of the error over the separate error interface 142. The PiM resource manager 108 can receive the error data over the error interface 142 and can take an appropriate remedial action. For example, the PiM resource manager 108 can initiate a PiM reset command that causes the memory device 122 to selectively reset the compute elements via a power control switch without resetting the memory arrays, thereby preserving stored data, as described in further detail below with reference to FIGS. 2-4. The reset can be triggered by a mode register write (MRW) command from the SoC 102, as described in further detail below with reference to FIGS. 3 and 4.

In some implementations, the PiM resource manager 108 can reset the state of the memory device 122 using the error data received over the error interface 142. That is, the system can perform this reset selectively, without affecting the memory arrays, by issuing the MRW command to set a designated MR bit, which activates a power control switch that disconnects and reinitializes the compute elements. The PiM resource manager 108 can then restart the PiM operations from an appropriate starting place, e.g., from an appropriate instruction sequence, which can often avoid performing redundant computations in the face of an error.

Thus, by enabling error detection of PiM operations through integrated compute elements within the memory device 122, the system significantly reduces data movement between memory and the SoC 102, lowering latency and improving energy efficiency for memory-bound workloads. The inclusion of dedicated debug and error reporting mechanisms, such as the error interface 142, enhances system reliability by facilitating early error detection and comprehensive post-error analysis. Additionally, the ability to selectively reset only the compute logic, without disturbing the memory arrays, allows for fast recovery from transient PiM logic faults while preserving application data integrity.

FIG. 2 illustrates an example system 200 that uses a processor-in-memory (PiM) architecture, providing an overview of the additional components in a rank and bank to support PiM. In particular, the figure shows how each DRAM rank (e.g., DRAM Rank 0) includes centralized control and resource blocks that coordinate operations across multiple memory banks (e.g., banks B0-B15), each of which is equipped with a dedicated PiM compute block.

Each bank (such as banks B0, B1, . . . , B14, and B15 depicted in FIG. 2) has a corresponding PiM block/compute and associated output registers. These compute units execute PiM instructions in parallel, enabling local processing of data stored in the memory arrays. By colocating compute and memory resources, the architecture minimizes the latency and bandwidth penalties. Additionally, each rank (such as DRAM Rank 0 depicted in FIG. 2) includes a centralized resource to manage and/or control operations required at rank level granularity, such as, e.g., input and output buffering, some control registers, etc. That is, the centralized resource can manage scheduling, command routing, and buffer management, and may include control registers, command routing, and coordination logic. This hierarchical design enables efficient organization and synchronization of compute workloads distributed across multiple banks.

As described above, within this PiM logic, certain types of errors can occur. These can include invalid PiM commands (e.g., malformed or unsupported instructions), invalid fields in command (e.g., syntactic errors or unsupported encodings), invalid target registers (e.g., out-of-range register access), overflow or underflow in buffers/queues, and read-before write errors (e.g., where a PiM instruction attempts to access a queue or register before data has been written.

In the case where any such error occur, the PiM subsystem can record the particular error at the rank level using dedicated registers, as described in further detail below with reference to FIG. 3. The dedicated registers can include a debug status register, an operation counter register, and a command history register. Importantly, the dedicated registers enable the PiM subsystem to detect and report the error type, identify the operation that caused the error, and stop further execution to preserve a consistent debug state. The PiM subsystem can communicate the error information (e.g., the PiM operation execution data) using a dedicate error interface, which allows the host device to take corrective action (e.g., issuing a selective PiM logic reset).

FIG. 3 illustrates an example system 300 that uses a processor-in-memory architecture.

The system 300 includes an SoC 302 (such as, e.g., SoC 102 of FIG. 1), which is an example of a host device that can issue requests to a memory device 322 having a PiM architecture. The SoC 302 includes a CPU 310, a shared SRAM 320, a memory controller 370, a storage controller 380, a PiM resource manager 350, and a DSP 330.

The system 300 also includes a memory device 322 having a PiM architecture (an example of which is depicted in FIG. 2). This can include one or more DRAM devices (or other memory device(s)) that each additionally includes one or more compute elements that operate on and process data stored in the memory array 310 of memory dye 390 (the memory device 322 can include multiple such dies). The SoC 302 provides requests for these compute elements to perform sequences of instructions over a primary PiM interface 340. Each sequence of instructions can include an identifier.

The memory device 322 can include one or more DRAM dies (e.g., die 390), each including compute elements, control logic, and memory arrays 310. The compute elements execute PiM operations locally on stored data, offloading compute burden from the SoC. Instructions for these operations are transmitted via a primary PiM interface 340, while error-related information is routed back to the SoC via a dedicated error interface 342.

The dye 390 can include a collection of registers. As depicted in FIG. 3, the collection of registers can include a debug status register 392 (also referring to herein as error status register 392), a PiM command counter register 394, and a PiM command history register 396. If the memory device 322 includes multiple dies, each such dye can include the above-identified collection of registers as well as respective memory array(s) 310.

The debug status register 392 serves as a status register that identifies debug events and errors. That is, the debug status register 392 can store a bitfield representing a current error state of the PiM subsystem. In some implementations, the debug status register 392 can be a 32-bit register, where each bit can indicate a particular type of error. In some implementations, the host processor (e.g., CPU 310) can periodically check (e.g., via an interface, such as the error interface 342) the PiM operational status by reading the debug status register 392 such as queue overflows, underflows, invalid commands, or invalid register targeting. In an implementation, if all the bits of the debug status register 392 are 0, the host processor determines that the PiM operations are operating correctly and that there are no errors. On the other hand, if one or more bits of the debug status register 392 are 1, the host processor determines that there are errors in the execution of the PiM operations. Additionally, the location of each non-zero bit in the debug status register 392 can indicate a particular type of error.

In an alternative implementation, the dye 390 can additionally include a control register, which can perform an OR operator with respect to the 32-bits of the debug status register 392. This OR operation helps identify whether any of the bits of the debug status register 392 are non-zero and if so, the resulting value indicates that there is an error. This alternative approach has the benefit of reducing the status checking overhead that is associated with a bitwise comparison of each bit in the debug status register 392.

The PiM command counter register 394 maintains a count of the number of commands executed, with the count being incremented with each processed PiM command. In some implementations, the host processor (e.g., CPU 310) can check (e.g., via an interface, such as the error interface 342) the value of the PiM command counter register upon the occurrence of an error. The value of this counter can be used by control logic in the host processor to identify the series of commands that caused the error, e.g., by comparing with count values in an offline trace.

The PiM command history register 396 maintains a log of the most-recently executed PiM commands/operations, which can include, e.g., the current row and column information. As one skilled in the art will appreciate, when an error occurs in the execution of PiM commands/operations, the PiM logic stops executing further commands/operations. In some implementations, when an error occurs, the host processor (e.g., CPU 310) can check (e.g., via an interface, such as the error interface 342) the value of the PiM command history register, which identifies the last n PiM commands/operations that were executed. The host processor can use this value then during error debugging to identify the commands that caused the error.

In some implementations, control logic executing at the memory device 322 can be configured to update PiM command history register 396 and the PiM command counter register 394 as each PiM command/operation is executed. In some implementations, such register updates can be done at the rank level granularity of the memory device 322. Moreover, in some implementations, upon the occurrence of an error in PiM execution, the PiM control logic can be configured to (1) update one or more bits of the debug status register 392 and (2) stop PiM execution so as to preserve the most recently-updated values of the PiM command counter register 394 and the PiM command history register 394. That is, if an error is detected (e.g., a malformed command or buffer overflow), the PiM logic updates the debug status register 392 and stops further operations, which allows the command counter 394 and history register 396 to retain a consistent and complete trace of operations leading up to the error.

In some implementations, the host processor (e.g., CPU 310) can periodically check the value of the debug status register 392 and if an error is identified based on the value of the register, the host processor can further read the values of the PiM command counter and command history registers 394 and 396. Alternatively, the host processor can periodically access the values of all three registers at once and then use the values of all three registers to evaluate whether there was an error in PiM execution and thereafter use the values of the command counter and history registers for error debugging.

Alternatively, the PiM control logic can be configured to detect an error (e.g., based on a read of the value from the debug status register 392) and provide, via the error interface and to the host processor (e.g., CPU 310), one or more of the following values: (1) the type of error encountered (e.g., as identified by the specific non-zero bit(s) of the debug status register 392, (2) the value of the PiM command counter register 394, and (3) the value of the PiM command history register 396.

Based on the received values of one or more of the registers 392, 394, and 396, the host processor can perform debugging operations, e.g., to identify the specific error that occurred and the command(s) that led to or caused the error.

In some implementations, the SoC can then perform a remedial action in response to the detection of the error during PiM command execution. The remedial action can depend on the specific type of error that has occurred. For example, if the error is isolated to logic associated with PiM execution, such as a control fault, queue overflow, or invalid command decoding, the SoC can initiate a targeted reset of the PiM logic, as described further below with reference to FIG. 4. Another example remedial action is to perform a full reset the entire memory device (e.g., memory device 322). However, as explained above and as one skilled in the art will appreciate, this latter remedial operation can be inefficient due to high latency and flow complexity, relative to the PiM logic only reset.

FIG. 4 illustrates an example system 400 that uses a processor-in-memory architecture, and which is configured to reset only PiM logic upon an error occurring during PiM command execution. This figure illustrates an example system that includes a power down and restart mechanism for PiM peripheral logic only. This configuration enables low-latency recovery of PiM functionality while preserving the integrity of data stored in the main memory arrays.

In some implementations, the recovery mechanism after an error has occurred, as illustrated in the figure and as further described below, is limited to the PiM logic, not to the entire memory device. Such selective resetting of only the PiM logic further ensures that the content stored in the memory device is not impacted and/or erased when an error occurs in the PiM logic.

As illustrated in FIG. 4, the PiM memory device 470 (which can be, e.g., the memory devices 122 and 322) can be a DRAM device, which can include DRAM block 410 and PiM logic 420. The DRAM block includes one or more memory array(s) 412 and memory logic 414. The PiM logic 420 includes a register file 422 and one or more PiM compute blocks 424.

The PiM memory device 470 further includes a command decoder 430 that is coupled to a bus 460, which in turn is coupled to the SoC (e.g., SoC 102 and 302). In response to detecting an error of the PiM subsystem, as discussed with reference to FIGS. 2 and 3, the SoC can send (e.g., transmit), over bus 460 and to the command decoder 430, a command requesting initiation of the reset of the PiM logic 420. The command decoder 430 decodes the received command and sends the reset PiM logic command to the PiM reset control block 440.

A power supply 450 is directly coupled to the DRAM block 410 and indirectly coupled to the PiM logic via a power control switch 480, as shown in FIG. 4. The power control switch is controlled by the PiM control block 440. For example, if the PiM control block receives a PiM logic reset command from the command decoder 430, the PiM control block is configured to control the power control switch 480, which results in only the PiM logic 420 being powered down and then restarted (without interrupting power to the DRAM block 410).

In some implementations, the PiM reset control block 440 controls the power control switch 480 using dedicated mode register (MR) bits and the circuit toggling the power control switch 480 is controlled based on these MR bits. In such implementations, the SoC can reset the PiM logic by issuing a mode register write (MRW) command to set the designated MR bits of the PiM reset control block 440. This MRW command may be issued upon detection of a PiM execution error, as indicated by the debug status register 392 described in FIG. 3. Based on these designated MR bits, the power switch 480 is controlled so as to power down and then re-supply power to the to the PiM logic 420 (e.g., without interrupting operation of the memory arrays).

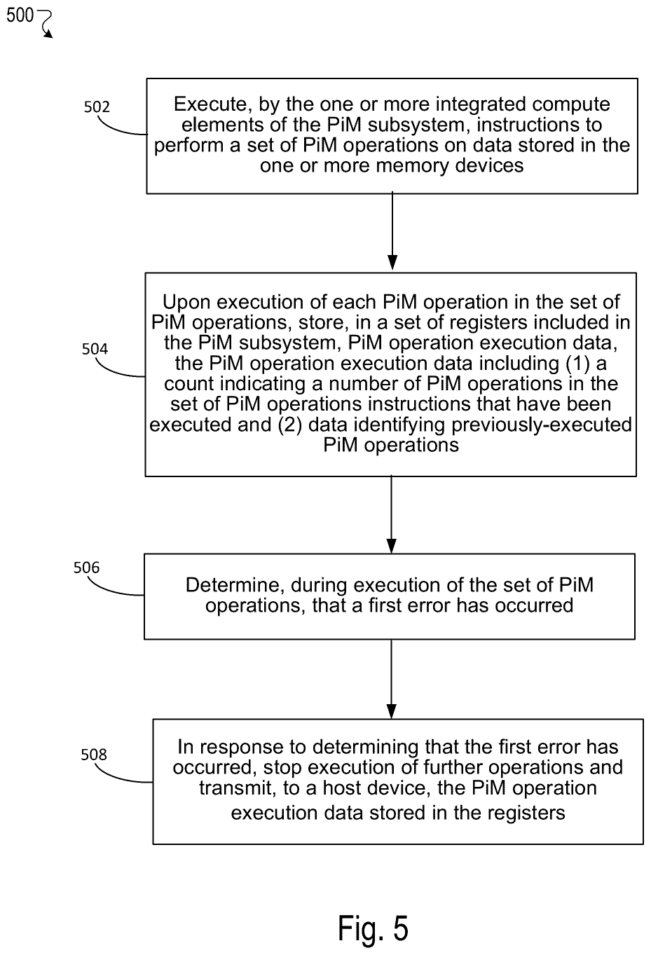

FIG. 5 is a flow diagram of an example process 500 for error detection of the PiM subsystem.

The system can execute, by the one or more integrated compute elements of the PiM subsystem, instructions to perform a set of PiM operations on data stored in the one or more memory devices (502).

The system can, upon execution of each PiM operation in the set of PiM operations, store, in a set of registers included in the PiM subsystem, PiM operation execution data, the PiM operation execution data including (1) a count indicating a number of PiM operations in the set of PiM operations instructions that have been executed and (2) data identifying previously-executed PiM operations (504). The set of registers can include an operation counter register and an operation history register, where the operation counter register can store the count indicating the number of PiM operations in the set of PiM operations instructions that have been executed, and where the operation history register can store data identifying previously-executed PiM operations until the error occurred.

The system can determine, during execution of the set of PiM operations, that a first error has occurred (506). In particular, the system can detect an error in execution of the set of PiM operations, and, in response to detecting the error, the system can update a value of an error status register. The value of the error status register can indicate a type of error for the first error.

The system can, in response to determining that the first error has occurred, stop execution of further operations and transmit, to a host device, the PiM operation execution data stored in the registers (508). The host device can include a CPU. In some examples, the host device can be a system-on-a-chip having multiple computing components including the CPU.

In some examples, the system can execute, by the CPU, instructions to perform an operation including sending a PiM reset command to the PiM subsystem. The PiM reset command requests resetting power to the one or more integrated compute elements of the PiM subsystem. That is, the system can selectively reset power to the one or more integrated compute elements of the PiM subsystem.

In particular, the PiM subsystem can include a power control switch that couples the one or more integrated compute elements of the PiM subsystem to a power supply. In response to receiving the PiM reset command, the system can activate the power control switch to selectively reset power to the one or more integrated compute elements of the PiM subsystem. In this case, activation of the power control switch does not interrupt power to the one or more memory devices of the PiM subsystem.

In some examples, the system can receive the PiM reset command as an MRW command from the host device. Based on receiving the MRW command, the system can update an MR bit and control the power control switch of the PiM subsystem based on updating the MR bit.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.c., one or more modules of computer program instructions encoded on a tangible non transitory program carrier for execution by, or to control the operation of, data processing apparatus.

Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for error detection of a processing-in-memory (PiM) subsystem that includes a one or more integrated compute elements and one or more memory devices, the method comprising:
executing, by the one or more integrated compute elements of the PiM subsystem, instructions to perform a set of PiM operations on data stored in the one or more memory devices; upon execution of each PiM operation in the set of PiM operations, storing, in a set of registers included in the PiM subsystem, PiM operation execution data, the PiM operation execution data including (1) a count indicating a number of PiM operations in the set of PiM operations instructions that have been executed and (2) data identifying previously-executed PiM operations;
determining, during execution of the set of PiM operations, that a first error has occurred; and
in response to determining that the first error has occurred, stopping execution of further PiM operations and transmitting, to a host device comprising a central processing unit (CPU), the PiM operation execution data stored in the registers.

2. The method of claim 1, wherein:
the set of registers comprise an operation counter register and an operation history register;
the operation counter register storing the count indicating the number of PiM operations in the set of PiM operations instructions that have been executed; and
the operation history register storing data identifying previously-executed PiM operations until the error occurred.

3. The method of claim 1, further comprising:
executing, by the CPU, instructions to perform an error debugging operation based on the transmitted PiM operation execution data.

4. The method of claim 1, wherein determining that the first error has occurred comprises:
detecting, by the PiM subsystem, an error in execution of the set of PiM operations; and
in response to detecting the error, updating, by the PiM subsystem, a value of an error status register, wherein the value of the error status register indicates a type of error for the first error.

5. The method of claim 1, further comprising:
executing, by the CPU, instructions to perform an operation comprising sending a PiM reset command to the PiM subsystem, wherein the PiM reset command requests resetting power to the one or more integrated compute elements of the PiM subsystem.

6. The method of claim 5, further comprising:
selectively resetting, by the PiM subsystem, power to the one or more integrated compute elements of the PiM subsystem.

7. The method of claim 6, wherein the PiM subsystem comprises a power control switch that couples the one or more integrated compute elements of the PiM subsystem to a power supply, and wherein the method further comprises:
in response to receiving the PiM reset command, activating the power control switch to selectively reset power to the one or more integrated compute elements of the PiM subsystem, wherein activation of the power control switch does not interrupt power to the one or more memory devices of the PiM subsystem.

8. The method of claim 1, wherein the host device is a system-on-a-chip having a plurality of computing components including the CPU.

9. The method of claim 4, wherein executing, by the CPU, instructions to perform an operation comprising sending a PiM reset command to the PiM subsystem comprises:
receiving the PiM reset command as a mode register write (MRW) command from the host device;
updating a mode register (MR) bit based on receiving the MRW command; and
in response to updating the MR bit, controlling the power control switch of the PiM subsystem.

10. A system comprising:
a host device comprising a central processing unit (CPU);
a processing-in-memory (PiM) subsystem comprising one or more memory devices, one or more integrated compute elements, and a set of registers, wherein the PiM subsystem is configured to execute, by the one or more integrated compute elements, instructions to perform a set of PiM operations on data stored in the one or more memory devices and, upon execution of each PiM operation in the set of PiM operations, to store in the set of registers, PiM operation execution data, the PiM operation execution data including (1) a count indicating a number of PiM operations in the set of PiM operations that have been executed and (2) data identifying previously-executed PiM operations; and
wherein the PIM subsystem is configured to determine, during execution of the set of PiM operations, that a first error has occurred, in response to determining that the first error has occurred, to stop execution of further PiM operations, and to transmit, to the host device, the PiM operation execution data stored in the registers.

11. The system of claim 10, wherein:
the set of registers comprise an operation counter register and an operation history register;
the operation counter register configured to store the count indicating the number of PiM operations in the set of PiM operations instructions that have been executed; and
the operation history register storing data configured to identify previously-executed PiM operations until the error occurred.

12. The system of claim 10, wherein the CPU is configured to execute instructions to perform an error debugging operation based on the transmitted PiM operation execution.

13. The system of claim 10, wherein the PiM subsystem is configured to detect an error in execution of the set of PiM operations and in response to detecting the error, updating a value of an error status register, wherein the value of the error status register indicates a type of error that occurred.

14. The system of claim 10, wherein the CPU is configured to execute instructions to perform an operation comprising sending a reset command to the PiM subsystem, wherein the PiM reset command requests resetting power to the one or more integrated compute elements of the PiM subsystem.

15. The system of claim 14, wherein, in response to receiving the PiM reset command, the PiM subsystem is configured to selectively reset power to the one or more integrated compute elements of the PiM subsystem.

16. The system of claim 15, wherein:
the PiM subsystem comprises a power control switch that couples the one or more integrated compute elements of the PiM subsystem to a power supply, and
in response to receiving the PiM reset command, the PiM subsystem is configured to activate the power control switch to selectively reset power to the one or more integrated compute elements of the PiM subsystem, wherein activation of the power control switch does not interrupt power to the one or more memory devices of the PiM subsystem.

17. The system of claim 10, wherein the host device is a system-on-a-chip having a plurality of computing components including the CPU.

18. The system of claim 14, wherein the PiM subsystem controls the power control switch of the PiM subsystem based on a mode register (MR) bit.

19. The system of claim 18, wherein the PiM subsystem receives PiM reset command as a mode register write (MRW) command from the host device.

20. The system of claim 19, wherein the PiM subsystem is configured to update the MR bit based on receiving the MRW command and, in response to updating the MR bit, to control the power control switch of the PiM subsystem.
